(19) United States
(12) Patent Application Publication
(10) Pub. No.: US 2026/0141722 A1
(43) Pub. Date: May 21, 2026

(54) ARTIFICIAL INTELLIGENCE STATE INFERENCE MODEL

(71) Applicant: SNWC, Inc., New York, NY (US)

(72) Inventors: Sam Naparstek, New York, NY (US); Thomas Alexander Hutchinson, London (GB)

(21) Appl. No.: 19/388,431

(22) Filed: Nov. 13, 2025

Related U.S. Application Data
(60) Provisional application No. 63/721,215, filed on Nov. 15, 2024.

(51) Int. Cl. G06V 20/52; G06T 7/20; G06T 7/70; G06V 10/764; G06V 10/82; G06V 20/64; G06V 20/68; G06V 40/20

(52) U.S. Cl. CPC G06V 20/52; G06T 7/20; G06T 7/70; G06V 10/764; G06V 20/64; G06V 20/68; G06V 40/28; G06T 2207/20084; G06T 2207/30196; G06T 2207/30232; G06V 10/82

(57) ABSTRACT

The disclosure generally describes methods, software, and systems for refrigerator state detection. An opening of a door of a refrigerator is detected. The door covers a front opening of the refrigerator when the door is in a closed state. Images of a frontal area that is in front of the front opening of the refrigerator are recorded, by a set of imaging devices. Items in the frontal area are detected, based on the images. The items include at least a hand and a racked item located on one of the racks. Two-dimensional coordinates of the racked item are projected to a corresponding location on the one of the racks. A three-dimensional representation of current contents of the refrigerator are generated based on the corresponding location and a vertical location of the one of the racks. A current state of the refrigerator is updated based on changes between the three-dimensional representation of the current contents and a previously generated three-dimensional representation of previous contents of the refrigerator.

### CROSS-REFERENCE TO RELATED APPLICATION

This application claims the benefit of U.S. Provisional Application No. 63/721,215, filed Nov. 15, 2024, the contents of which are incorporated by reference herein.

### TECHNICAL FIELD

The present disclosure relates to item state detection. More particularly, implementations of the present disclosure are directed to state inference using artificial intelligence (AI).

### BACKGROUND

Modern item storage structures, including refrigerators, can be equipped with components that facilitate state detection. The state of storage structures can be determined by tracking changes in their contents over time. Technical challenges can limit the effectiveness of the state detection.

### SUMMARY

Implementations of the present disclosure are directed to techniques and tools for cabinet state detection, determination, and/or detecting. More particularly, implementations of the present disclosure are directed to cabinet state inference using artificial intelligence (AI). While refrigerators are discussed as a particular use case for purposes of example throughout this specification, it should be understood that this technology can be used in other use cases, such as unrefrigerated storage cabinets, drawers, etc. As such, the use of the term refrigerator (or related terms) can be replaced with a phrase describing another storage cabinet, drawer, etc. in descriptions of any of the figures or other descriptions.

A technical challenge to obtaining an accurate and useful state of a refrigerator (or another storage cabinet, drawer, etc.) relates to data accuracy. For example, due to the nature of how a refrigerator is used and physically designed, the sensors may not be able to reliably and accurately detect and report the quantity and/or condition of items placed within, currently within, or removed from refrigerators. In a specific example, cameras used to detect items stored in a refrigerator may not be able to capture items that are occluded by other items. Furthermore, it can be difficult to determine when an item is inserted into or removed from the refrigerator based on images/video captured using cameras, for example, because features of the item may be occluded by a body part (e.g., hand) or portion of a mechanism that is inserting or removing the item or another occlusion that is part of the refrigerator structure. This can lead to incorrect determinations of the state of the refrigerator and/or other inaccurate data. These types of inaccurate data can lead to discrepancies that negatively impact operations relying on the state determination. Additionally, connectivity issues and delays in data transmission can affect the timeliness of state updates, further limiting the effectiveness of refrigerator state determinations. The described tool limitations can restrict the overall applicability of refrigerator state detection, and prevent successful operation of “smart” refrigerators.

To overcome these technical challenges, e.g., the inability of cameras to reliably capture images of items within a refrigerator and/or being added to/removed from the refrigerator, an artificial intelligence (AI) system is implemented improve the detection/determination of the state of a refrigerator. The AI system uses a combination of captured video frames, item detection, item projection, and action detection to more accurately determine the state of the refrigerator. For example, rather than relying on full visibility or detectability (e.g., using cameras) of an item being inserted, already placed within, or being removed from the refrigerator, the AI system is able to infer the state of the refrigerator by using action detection and item projection to determine whether an item was inserted into, removed from, or is currently resting within the refrigerator. In this way, the state of the refrigerator can be determined despite the fact that the sensors installed in the refrigerator are incapable of continuously capturing the locations of items. As such, the operation of the refrigerator is improved.

In some implementations, a method includes: detecting an opening of a door of a refrigerator, wherein the door covers a front opening of the refrigerator when the door is in a closed state, recording, by a set of imaging devices, images of a frontal area that is in front of the front opening of the refrigerator, detecting, based on the images, items in the frontal area, wherein the items include at least a hand and a racked item located on one of the racks, projecting two-dimensional coordinates of the racked item to a corresponding location on the one of the racks, generating a three-dimensional representation of current contents of the refrigerator based on the corresponding location and a vertical location of the one of the racks, and updating a current state of the refrigerator based on changes between the three-dimensional representation of the current contents and a previously generated three-dimensional representation of previous contents of the refrigerator.

The foregoing and other implementations can each optionally include one or more of the following features, alone or in combination. In particular, implementations can include all of the following features:

In a first aspect, combinable with any of the previous aspects, wherein recording images of a frontal area includes recording images of a given rack moving from inside the refrigerator into the frontal area, detecting items in the frontal area includes detecting the given rack in a frame among the images, the method further includes determining that the given rack is being opened based on detecting forward movement of the rack based on locations of the given rack in two or more of the images, and determining the vertical location of the given rack based on a width of a bounding box used to surround the given rack in the images. In another aspect, combinable with any of the previous aspects, the method further includes selecting a subset of the imaging devices to be used for action detection based on the vertical location of the given rack, wherein a first subset of the imaging devices is selected when the vertical location of the given rack indicates that the given rack is within a specified distance of the imaging devices, and a second subset of the imaging devices is selected when the vertical location of the given rack indicates that the given rack is beyond the specified distance of the imaging devices. In another aspect, combinable with any of the previous aspects, the method further includes performing the action detection based on an analysis of the hand over multiple frames of the images. In another aspect, combinable with any of the previous aspects, performing the action detection includes classifying the hand as one of an inactive hand, an active hand, or a retracting hand. In another aspect, combinable with any of the previous aspects, classifying the hand as the inactive hand includes classifying the hand as the inactive hand based on a determination that the hand is not holding the racked item, classifying the hand as an active hand includes classifying the hand as an active hand based on a determination that the hand is holding the racked item inside a boundary of the given rack, and classifying the hand as a retracting hand includes classifying the hand as a retracting hand based on a determination that the hand is holding the racked item and has transitioned from a first location that is inside a boundary of the given rack to a second location that is outside a boundary of the given rack. In another aspect, combinable with any of the previous aspects, the method further includes determining that a new racked item has been placed on the given rack based on a reclassification of the active hand to the inactive hand, wherein a racked location of the new racked item corresponds to a location at which the active hand was reclassified as the inactive hand. In another aspect, combinable with any of the previous aspects, updating the current state of the refrigerator includes including the new racked item in a list of items located on the given rack.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

These and other implementations can each optionally include one or more of the following advantages. The described implementation provides an efficient approach for automatic and accurate generation of refrigerator state updates. The refrigerator state updates are based on current contents of the refrigerator derived by AI models trained to process images to detect and track items. The described AI models can predict and identify action patterns indicative of item changes. The described implementations reduce the risk of error introduction in item identification and ensures an accurate identification of current contents of the refrigerator. As an advantage, the described implementations provide an enhanced refrigerator state accuracy and consistency. The described implementations also include data compression to optimize data transmission between the refrigerator and remote computing systems. As another advantage, the described data compression and transmission also includes controlled deletion of data from the refrigerator memory for continuous optimization of system storage resources.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1A is a block diagram of an example system used for refrigerator state detecting, according to some implementations of the present disclosure.

FIG. 1B is a circuit diagram of a portion of an example refrigerator used for refrigerator state detecting, according to some implementations of the present disclosure.

FIG. 1C is a perspective view of an example refrigerator used for refrigerator state detecting, according to some implementations of the present disclosure.

FIG. 2 is a flowchart of an example process for refrigerator state detecting, according to some implementations of the present disclosure.

FIG. 3A is an example visual representation of an example rack with items before distortion correction, according to some implementations of the present disclosure.

FIG. 3B is an example visual representation of an example rack with items after distortion correction, according to some implementations of the present disclosure.

FIG. 4A is a block diagram of an example rack representation created for refrigerator state detection, according to some implementations of the present disclosure.

FIG. 4B is a block diagram of an example rack with items detected after an action modifying a previous state of the example rack, according to some implementations of the present disclosure.

FIG. 4C is a block diagram of an example rack with items detected after image correction, according to some implementations of the present disclosure.

FIG. 5A is a flowchart of another example process for refrigerator state detecting, according to some implementations of the present disclosure.

FIG. 5B is a flowchart of another example process for refrigerator state detecting, according to some implementations of the present disclosure.

FIG. 5C is a flowchart of another example process for refrigerator state detecting, according to some implementations of the present disclosure.

FIG. 5D is a flowchart of another example process for refrigerator state detecting, according to some implementations of the present disclosure.

FIG. 6 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The present disclosure relates to a cabinet, such as a refrigerator state detection. More particularly, implementations of the present disclosure are directed to state inference, such as refrigerator state inference, using artificial intelligence (AI) as a tool. Refrigerator state detection is a structured methodology used to identify current contents of a refrigerator distributed throughout racks or other storage containers or surfaces such as buckets, trays, static shelves, bins of the respective refrigerator and the content modification during a refrigerator door opening. The refrigerator state detection can be initiated after detecting the opening of the refrigerator door. As a front opening of the refrigerator becomes accessible, any of the racks of the refrigerator can be pulled outwards. Any changes to the racked items can be recorded, by imaging devices. The recorded images are processed to detect the changes to the racked items in the frontal area. The detected items can be analyzed to generate a three-dimensional representation of current contents of the refrigerator and to update the current state of the refrigerator.

Some traditional state detection systems can include a combination of light sources, cameras, and sensors that have limited data collection capabilities, introducing errors related to incorrect data collection. For example, bright lightning can enhance data collection for items with low contrast matte exterior, while causing glare, when illuminating items with shiny exterior, limiting item identification capabilities. Other limitations of some traditional state detection systems can stem from inefficient analysis of collected data. For example, some limitations of traditional state detection protocols are attributed to the dependence on complete view of all racked items in the refrigerator (or other storage structure), which depends on generation of large data sets requiring time consuming data processing. Other limitations of traditional state detection systems stem from a disproportion between available resources and requests for rapid delivery times characterizing modern software systems.

Addressing the limitations of traditional state detection protocols, the automatic state detection described in the present disclosure provides an increase in the accuracy of item identification based on an optimized data collection, data transmission, and data analysis. For example, the described solution overcomes potential challenges in data collection by combining a variety of imaging device settings within a uniformly and diffusely lighting conditions, ensuring efficient item identification, independent of a light reflectance value of the item exterior. The described approach optimizes data volume collection and data storage by limiting the data collection to open door events. The described approach optimizes data transmission by preprocessing the collected data to minimize transmitted data volume. The described approach combines prediction models to support racked item identification by automatically classifying hand actions and tracking items to optimize data analysis. In the described solution, the prediction model can be trained to process images to classify hand actions and to track items using known movement patterns corresponding to item placement on a rack or item removal from the refrigerator (or other storage structure). The approach broadens the scope of prediction models by advantageously addressing considerations regarding optimization, accuracy, and adaptability in handling diverse rack placement configurations for state detection. The tracked items are analyzed relative to positions within a respective rack to extract a three-dimensional representation of current contents of the refrigerator (or other storage structure) based on the corresponding location and a vertical location of the racks. The three-dimensional representation of current contents is related to previously generated three-dimensional representation of previous contents of the refrigerator (or other storage structure) increasing the accuracy of the determined state of the refrigerator (or other storage structure). Notably, the three-dimensional representation of the current contents of the refrigerator (or other storage structure) can be inferred based on two dimensional images captured by cameras, such that the three-dimensional representation can be achieved using standard two-dimensional cameras. Item type and item location identification can be derived strictly from image processing without relying on any other sensors, such as pressure, weight or motion sensors, visual cues/product identifiers or any other conceivable additional sensors. A benefit of item identification based on a limited number of sensors is given by a minimized risk of sensor breakage, minimized sensor software synchronization, and fewer risks of false negatives or positives from different sensors.

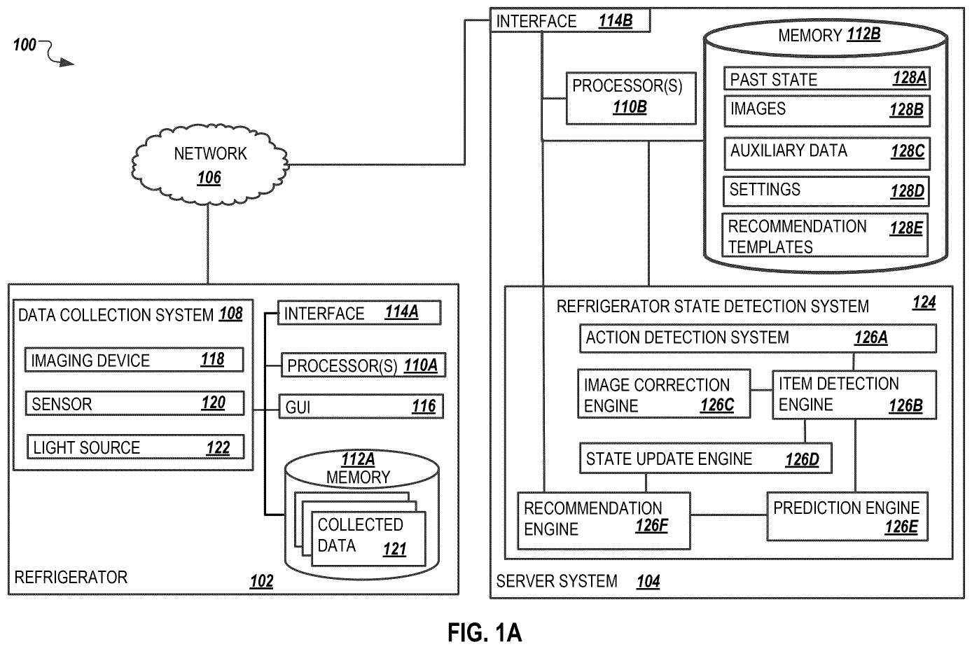

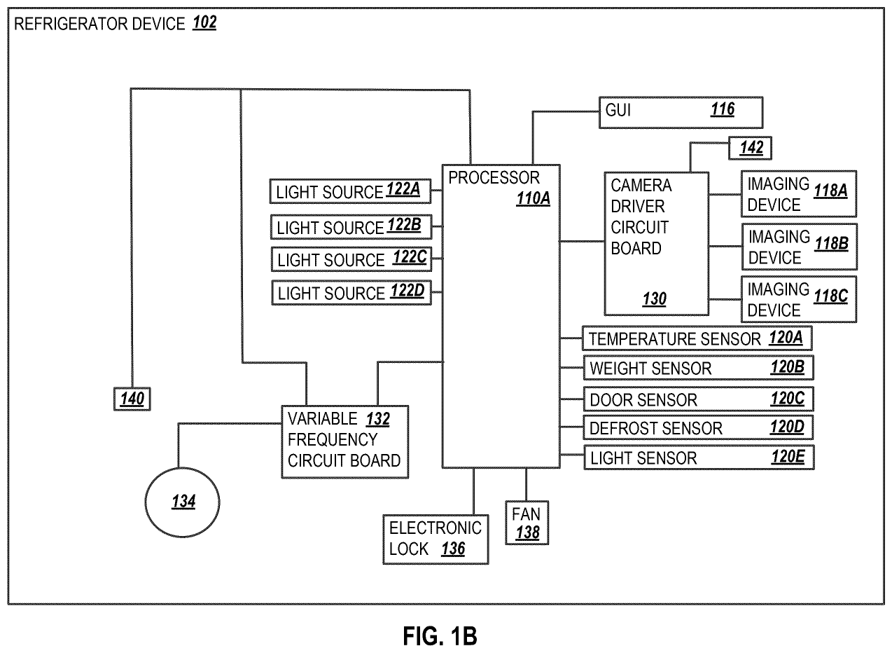

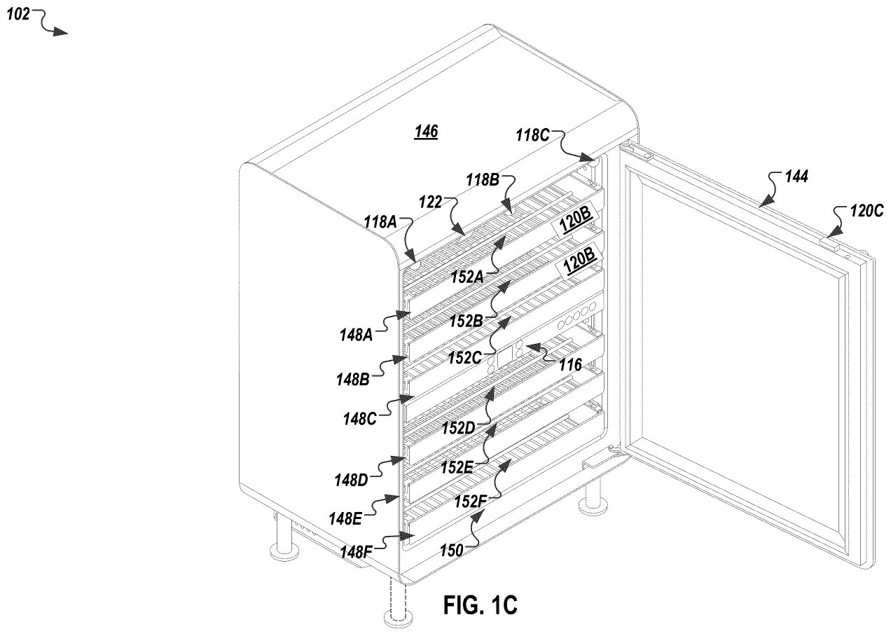

FIG. 1A is a block diagram of an example system 100 for state detection, according to some implementations of the present disclosure. Specifically, the illustrated example system 100 includes or is communicably coupled with a refrigerator 102, a server system 104, and a network 106. Although shown separately, in some implementations, functionality of two or more systems or servers can be provided by a single system or server. In some implementations, the functionality of one illustrated system, server, or component can be provided by multiple systems, servers, or components, respectively. As previously mentioned, the following descriptions refer to a refrigerator to provide a real world use case, but the descriptions of state detection that follow are equally applicable to other use cases, such as detecting the states of other storage structures (e.g., drawers, cabinets, pantries, etc.).

In general, the refrigerator 102 can be an electronic device operable to detect items stored on multiple racks. The refrigerator 102 includes a data collection system 108, a processor 110A, a memory 112A, an interface 114A, and a graphical user interface (GUI) 116 (optional). The processor 110A controls the data collection system 108, the interface 114A, and the GUI 116, to collect data for detecting the items stored on the racks. The data collection system 108 includes one or more imaging devices 118, one or more sensors 120, and one or more light sources 122. The one or more sensors 120 can detect events (e.g., refrigerator door opening) and generate sensor data for initiating data collection. The one or more light sources 122 can be activated during data collection. The one or more imaging devices 118 can be activated to collect data including images. The refrigerator 102 can temporarily store, in the memory 112A, the collected data 121. The collected data 121 stored, in the memory 112A, can include sensor data, images, time stamps and other data collection information. The processor 110A of the refrigerator 102 can process the collected data 121 and can transmit the data, to the server system 104. The refrigerator 102 can receive recommendations, from the server system 104 that can be displayed by the GUI 116. The GUI can be part of the physical refrigerator, or can be part of another device (e.g., a mobile device) that is not physically part of the refrigerator.

In some implementations, the processor 110A, the memory 112A, the interface 114A, and the GUI 116 can be included in a user device. The user device can include an electronic computer device operable to receive, transmit, process, and store any appropriate data associated with the refrigerator 102 of FIG. 1. The user device can encompass any client computing device such as a laptop/notebook computer, wireless data port, smart phone, personal data assistant (PDA), tablet computing device, one or more processors within these devices, or any other suitable processing device. The user device can include one or more applications that allow a user device to request and view content on the user device (e.g., generate a list of current and past items stored in the refrigerator 102). In some implementations, an application can use collected data 121 and other data to access the refrigerator state detection system 124 of the server system 104. In some instances, an application can be an agent or client-side version of the one or more enterprise applications running on an enterprise server (not shown).

For example, the refrigerator 102 can include a computer that includes one or more of an input device, such as a keypad, touch screen, or other device that can accept user information, and an output device that conveys information associated with the operation of the server system 104, or the user device itself, including digital data, visual information, or a GUI 116. The GUI 116 can provide an efficient and user-friendly presentation of data provided by or communicated within the system. The GUI 116 can include a plurality of customizable frames or views having interactive fields, pull-down lists, and buttons operated by the user. The GUI 116 can include any suitable graphical user interface, such as a combination of a generic web browser, intelligent engine, and command line interface (CLI) that processes information and efficiently presents the results to the user visually. In some implementation, the GUI 116 may be physically distant from the refrigerator 102. For example, the GUI 116 can be provided in a mobile application executing on a telecommunications device (e.g., smart phone), a tablet device, a desktop device, a wearable device, or another computing device that is implemented separate from the refrigerator 102.

In the example of FIG. 1A, the server system 104 is intended to represent various forms of servers including, but not limited to a web server, an application server, a proxy server, a network server, and/or a server pool. In general, server systems 104 accept requests for application services including refrigerator state detection services and provides such services to any number of refrigerators 102 and one or more user devices connected over the network 106. In accordance with implementations of the present disclosure, and as noted above, the server system 104 can host a solution environment that can be a cloud environment providing software applications, systems, and services that can be consumed by refrigerators 102 and one or more user devices, as a service. In some instances, the server system 104 can provide services to refrigerators 102 of different types (e.g., including different settings and rack configurations), different camera configurations (e.g., numbers, types and location of cameras), and can support execution of defined processes associated with refrigerator state detection, including display of recommendations. For example, the server system 104 includes a refrigerator state detection system 124, a processor 110B, a memory 112B, and an interface 114B.

The refrigerator state detection system 124 can include an action detection system 126A, an item detection system 126B, an image correction engine 126C, a state update engine 126D, a prediction engine 126E, and a recommendation engine 126F. The refrigerator state detection system 124 is coupled to the processor 110B, the memory 112B, and the interface 114B for refrigerator status detecting using data stored in the memory 112B. The memory 112B can include a past refrigerator state 128A, images 128B, auxiliary data 128C, refrigerator settings 128D, and recommendation templates 128E. Further, the memory 112B can include a database of item data including but not limited to an item identifier, an item name, ingredients, a brand, a barcode, and a universal product code. The images 128B can be stored as vector representations of item images and the corresponding item identifier, forming an embeddings database. The embeddings database can be implemented as a graph database or a convoluted neural network. Each item can have one or more entries in the embeddings database, for example, to store the images 128B of an item from multiple angles, under different lighting conditions, and to account for variations in item packaging. In some implementations, AI models, such as a convoluted neural network (CNN) can be used to generate the embeddings.

For example, as refrigerators 102 generate requests for refrigerator state detection based on images 128B and auxiliary data 128C, the refrigerator state detection system 124 can be used to update a current state of the refrigerator 102. The images 128B and the auxiliary data 128C can be transmitted to the action detection system 126A to detect an action and trigger the item detection system 126B to extract items from the images 128B. The images 128B are corrected, by the image correction engine 126C, to remove distortions and are saved in the memory 112A as corrected images. The state update engine 126D can process the corrected images to update a current state of the refrigerator. The state update engine 126D can send the current state of the refrigerator to the recommendation engine 126F and to the memory 112A for storage. The recommendation engine 126F can process the current state of the refrigerator to generate recommendations formatted according to recommendation templates 128E. The recommendation engine 126F can send the recommendations to the refrigerator 102 to be displayed on a graphical user interface (GUI) 116 and stored in the memory 112A. The image correction engine 126C and the recommendation engine 126F can communicate with the prediction engine 126E to process the data. The prediction engine 126E can use a first prediction model trained for object detection to increase an accuracy of item detection. The prediction engine 126E can use a second prediction model to produce the recommendations transmitted to the refrigerator 102. In some implementations, any or all of the components of the example system 100, both hardware or software (or a combination of hardware and software), can interface with each other or the interface(s) 1114A, and 114B (or a combination of both) over the network 106 for refrigerator state detection.

In some implementations, the network 106 can include a computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 106, is transferred using any number of network layer protocols, such as Internet Protocol (IP), Multiprotocol Label Switching (MPLS), Asynchronous Transfer Mode (ATM), Frame Relay, etc. Data can also be transmitted using inter-process communication (IPC) for the case the server system 104 is running on the same hardware as the refrigerator system 102. Furthermore, in implementations where the network 106 represents a combination of multiple sub-networks, different network layer protocols are used at each of the underlying sub-networks. In some implementations, the network 106 represents one or more interconnected internetworks, such as the public Internet.

Each processor 110A, 110B included in the refrigerator 102 can be a central processing unit (CPU), an application specific integrated circuit (ASIC), a field-programmable gate array (FPGA), or another suitable component. Each processor 110A, 110B included in the refrigerator 102 executes instructions and manipulates data to perform the operations of the refrigerator 102, respectively. Specifically, the processor 110A included in the refrigerator 102 executes the functionality required to send collected data 121 to the server system 104. Any sets of collected data 121 that are successfully uploaded, to the server system 104, are deleted from the built-in memory 112A. If the storage capacity of the memory 112A is low, the processor 110A can automatically delete videos or images to increase the storage capacity, starting with the oldest collected data 121 first until an adequate storage capacity of the memory 112A is freed. The processor 110A can receive and process responses from the server system 104. Each processor 110A, 110B can be a CPU, a blade, an ASIC, a FPGA, or another suitable component. Each processor 110A, 110B executes instructions and manipulates data to perform the operations of the respective system (e.g., the refrigerator 102 and the server system 104). Specifically, each processor 110A, 110B executes the functionality required to receive and respond to requests from the respective system (e.g., the refrigerator 102 and the server system 104).

Interfaces 114A, 114B are used by the refrigerator 102 and the server system 104, respectively, for communicating with other systems in a distributed environment—including within the system 100—connected to the network 106. Generally, the interfaces 114A, 114B each include logic encoded in software and/or hardware in a suitable combination and operable to communicate with the network 106. More specifically, the interfaces 114A, 114B can each include software supporting one or more communication protocols associated with communications such that the network 106 or interface's hardware is operable to communicate physical signals within and outside of the illustrated system 100.

The memory 112A, 112B can include any type of memory or database module and can take the form of volatile and/or non-volatile memory including, without limitation, magnetic media, optical media, random access memory (RAM), read-only memory (ROM), removable media, or any other suitable local or remote memory component. The memory 112A, 112B can store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server system 104, or the refrigerator 102, respectively.

There can be any number of refrigerators 102 and user devices associated with, or external to, the system 100. For example, the example system 100 can include one or more user devices external to the illustrated portion of system 100 that are capable of interacting with the system 100 via the network(s) 106. Further, the term “client,” “user device,” and “user” can be used interchangeably as appropriate without departing from the scope of the disclosure. Moreover, while user device can be described in terms of being used by a single user, the disclosure contemplates that many users can use one computer, or that one user can use multiple computers. As used in the present disclosure, the term “computer” is intended to encompass any suitable processing device. For example, although FIG. 1A illustrates a single refrigerator 102 and a single server system 104, the system 100 can be implemented using a single, stand-alone computing device, two or more servers 104, or multiple refrigerators 102. The server system 104, and the refrigerator 102 can include any computer or processing device such as, for example, a blade server, general-purpose personal computer workstation, or any other suitable device. In other words, the present disclosure contemplates computers other than general purpose computers, as well as computers without conventional operating systems. Further, the server system 104 and the refrigerator 102 can be adapted to execute any operating system or runtime environment. According to one implementation, the server system 104 can also include or be communicably coupled with an e-mail server, a Web server, a caching server, a streaming data server, and/or another suitable server.

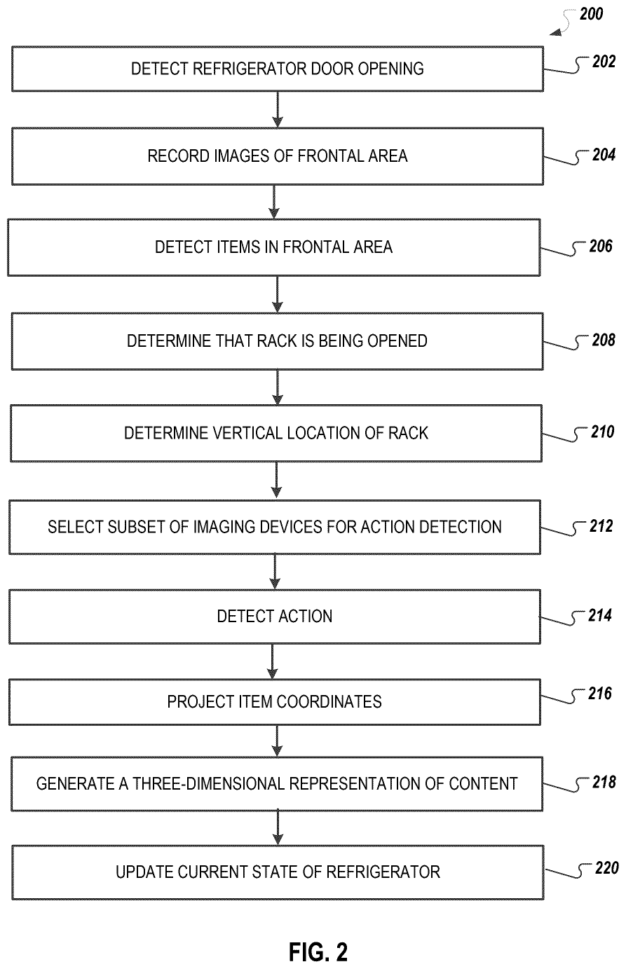

Regardless of the particular implementation, “software” can include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language. The software can include multiple sub-modules, third-party services, components, libraries, and such, as appropriate. Conversely, the features and functionality of various components can be combined into single components as appropriate. The communication between the refrigerator 102 and the server system 104 can include several different communication protocols configured to optimize refrigerator state detection, as further described in detail with reference to FIGS. 2-6.

FIG. 1B is a circuit diagram of a portion of an example refrigerator 102 used for refrigerator state detection, according to some implementations of the present disclosure. The example refrigerator 102 includes a processor 110A, a GUI 116, imaging devices 118A-118C, sensors 120A-120E, light sources 122A-122D, a camera driver circuit board 130, a variable frequency circuit board 132, a compressor 134, an electronic lock 136, fans 138, a power plug 140, and an antenna 142.

The processor 110A can be the processor 110A described with reference to FIG. 1A. The processor 110A can controlling the operations executed by the refrigerator 102. The processor 110A receives inputs from the sensors 120A-120E and controls image acquisition using the imaging devices 118A-118C. The processor 110A controls the compressor 134, the fans 138, light sources 122A-122D, and other components of the refrigerator 102. The GUI 116 can be the processor 110A described with reference to FIG. 1A.

The imaging devices 118A-118C can include digital cameras including electronic sensors (e.g., complementary metal-oxide-semiconductor or charge-coupled Device), red, green, blue (RGB) cameras, RGB depth cameras, infrared cameras, light detection and ranging (LIDAR) sensors and any other type of imaging device The imaging devices 118A-118C can be placed inside the refrigerator 102 to detect items stored on racks. The imaging devices 118A-118C can transmit the images to the processor 110A to be processed, to provide real-time state updates about the refrigerator 102.

The sensors 120A-120E can include a temperature sensor 120A, a weight sensor 120B, a door sensor 120C, a defrost sensor 120D, and a light sensor 120E. The temperature sensor 120A detects the internal temperature of the refrigerator 102 and send data to the processor 110A. The weight sensor 120B can measure the weight of each rack of the refrigerator 102.The door sensor 120C can detect when the refrigerator door is open or closed. The defrost sensor 120D measures the temperature of evaporator coils of the refrigerator 102 to detect frost buildup. The light sensor 120E can measure light intensity within the refrigerator 102.

The light sources 122A-122D are used to illuminate the interior of the refrigerator 102. The light sources 122A-122D can include artificial light sources, such as light-emitting diodes (LED) lights or fluorescent lights. The light sources 122A-122D are used to illuminate the interior of the refrigerator 102. The light sources 122A-122D can be controlled by the processor 110A, which can adjust the brightness based on a door state, as indicated by the door sensor 120C and based on a light intensity detected by the light sensor 120E. The light sources 122A-122D can be controlled to generate a uniformly distributed diffused light to minimize glaring and shadows in images acquired by the imaging devices 118A-118C. In some implementations, the light sources 122A-122D can be designed as spotlights or strip lights that can be covered by light filters (e.g., diffusers) to soften and spread light evenly. The camera driver circuit board 130 interfaces with the imaging devices 118A-118C, processes the video feed to optimize it for transmission, and sending the processed data to the processor 110A for further analysis.

The variable frequency circuit board 132 controls the speed of the motor of the compressor 134. By varying the frequency of the power supplied to the compressor 134, the variable frequency circuit board 132 can adjust the cooling capacity as indicated by the processor 110A, improving the energy efficiency of the refrigerator 102 (thermoelectric storage cabinet). The compressor 134 is responsible for circulating the refrigerant through the system. The compressor 134 compresses the refrigerant, raising its pressure and temperature, which is then cooled in a condenser of the refrigerator 102. The fans 138 are used to circulate air within the refrigerator 102 and across the condenser coils. The fans 138 maintain a uniform temperature and efficient heat exchange.

The electronic lock 136 can be used to secure the refrigerator 102. The electronic lock 136 can be controlled by the processor 110A and can be activated or deactivated via a keypad of the GUI 116 or a remote signal. The power plug 140 connects the refrigerator 102 to the electrical outlet, supplying power to the components of the refrigerator 102. The antenna 142 can be connected or included to the interface 114A to be used for wireless communication, facilitating a connection over the network between the refrigerator 102 and a server system 104, as shown in FIG. 1A.

FIG. 1C is a perspective view of an example refrigerator 102 used for refrigerator state detection, according to some implementations of the present disclosure. The refrigerator 102 according to an implementation includes a door 144 and a cabinet body 146. The cabinet body 146 defines a storage space and the door 144 is disposed on a front surface of the cabinet body 146 to open and close the storage space articulating out, as detected by door sensor 120C.

The door 144 can provide thermal insulation for the example refrigerator 102. In some implementations, the door 144 can be mounted on the outside of the refrigerator 102. In some implementations, the cabinet body 146 can be enclosed within an outer cabinet (e.g., custom built cabinetry or multiple refrigerated cabinets 102 can be placed adjacent to each other within the outer cabinet) and the one or more door sensor 120C are configured to detect an opening of one or more doors 144. The door sensor 120C can include a magnetic sensor, a time of fight (ToF) sensor, pressure sensor, and/or a reed switch sensor used to detect when the door 144 is opened and when the door 144 is closed.

The storage space within the cabinet body 146 can include multiple racks 148A-148F. The racks 148A-148F can be pull-out drawers disposed inside the refrigerating storage space within the cabinet body 146. The racks 148A-148F are slidable outwards in front of the front opening 150 of the refrigerator 102. Each of the racks 148A-148F can include a storage area 152A-152F that is accessible when the racks 148A-148F are pulled outwards. Each of the racks 148A-148F can include a weight sensor 120B detecting a weight variation of items stored in the storage area 152A-152F. The storage area 152A-152F can be imaged by the imaging devices 118A-118C and can be lighted by the light source 122.

The imaging devices 118A-118C can be attached to a top inner portion of the cabinet body 146. In some implementations, the imaging devices 118A-118C have different configurations and settings (e.g., aperture and focal lengths) to capture images of racks at different depths with minimal distortions. For example, the lateral imaging devices 118A, 118C (including standard resolution ultra-wide cameras) can be set to acquire images of near field racks 148A-148C. The central imaging device 118B can be set to record images of lower racks 148D-148F.

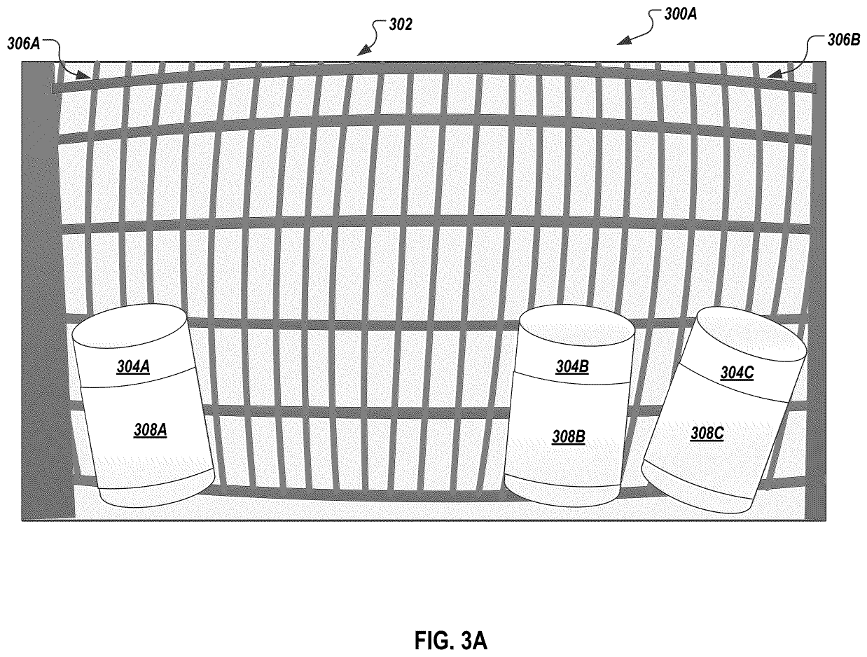

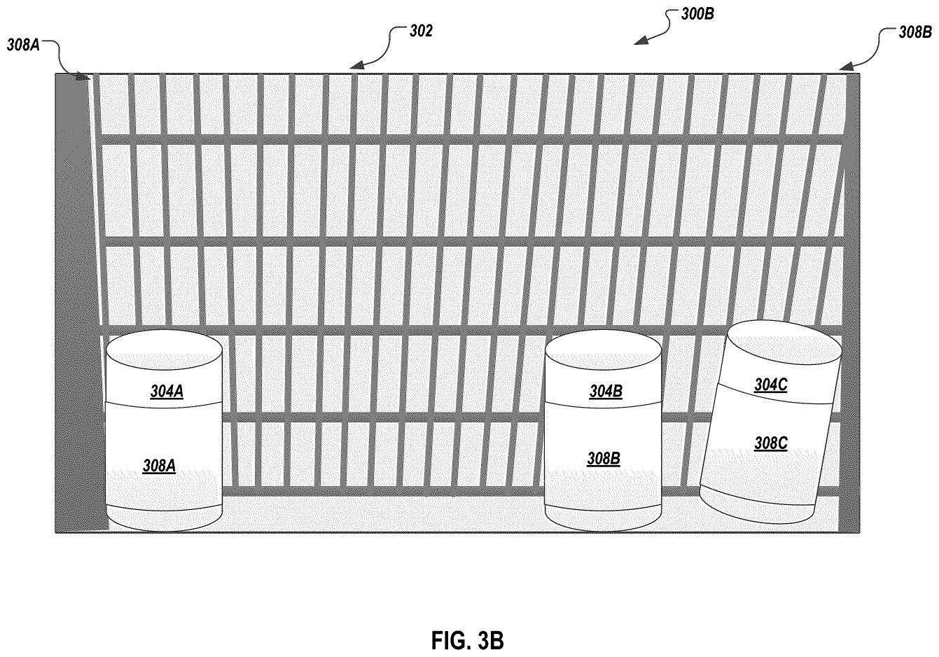

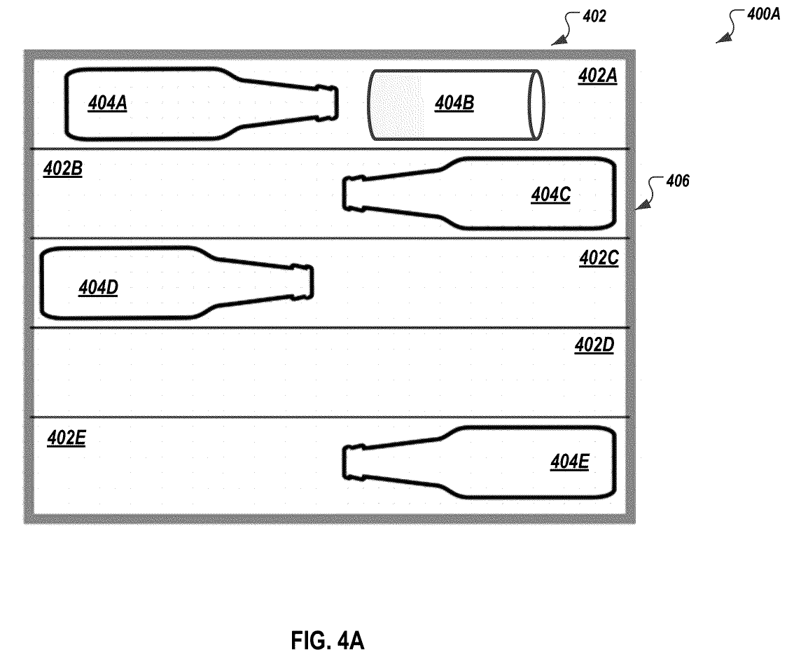

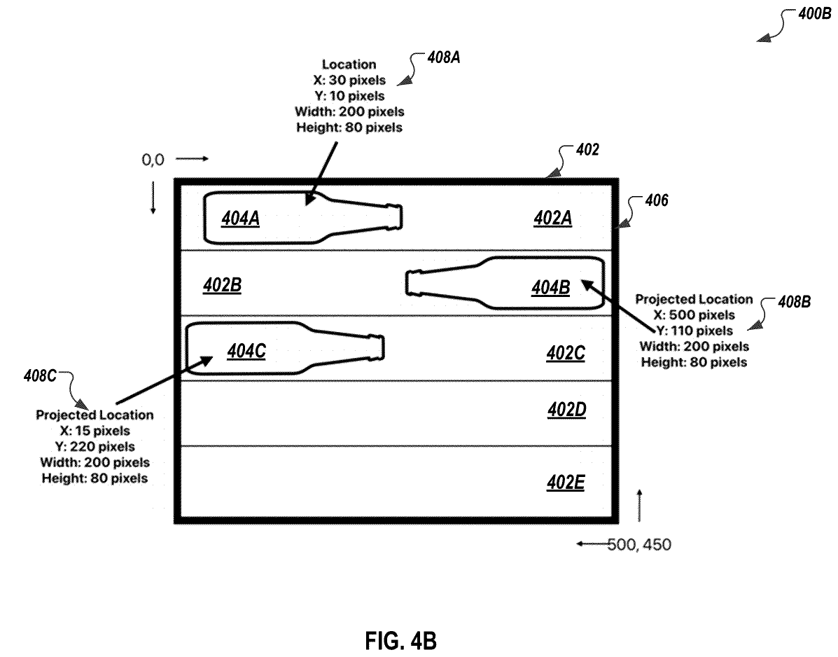

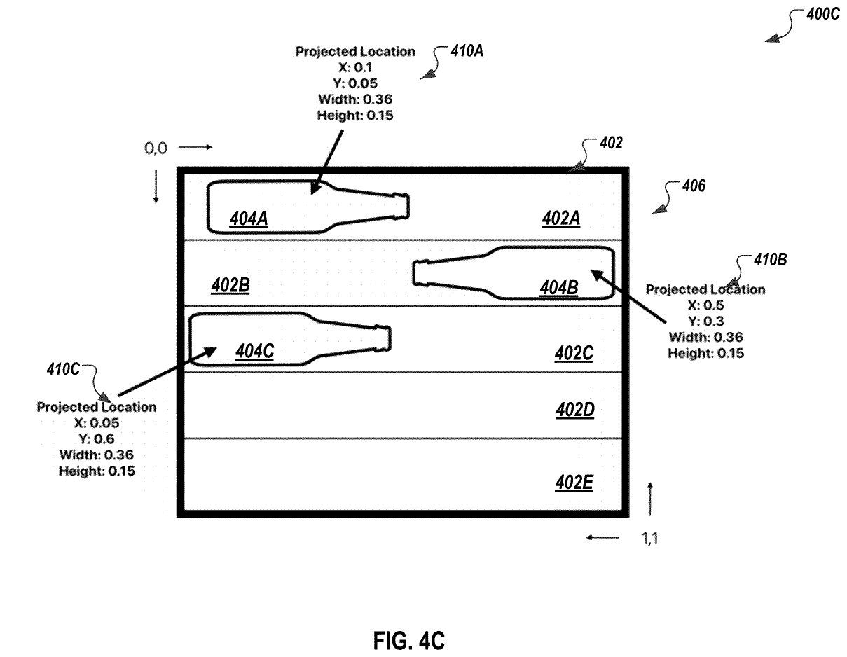

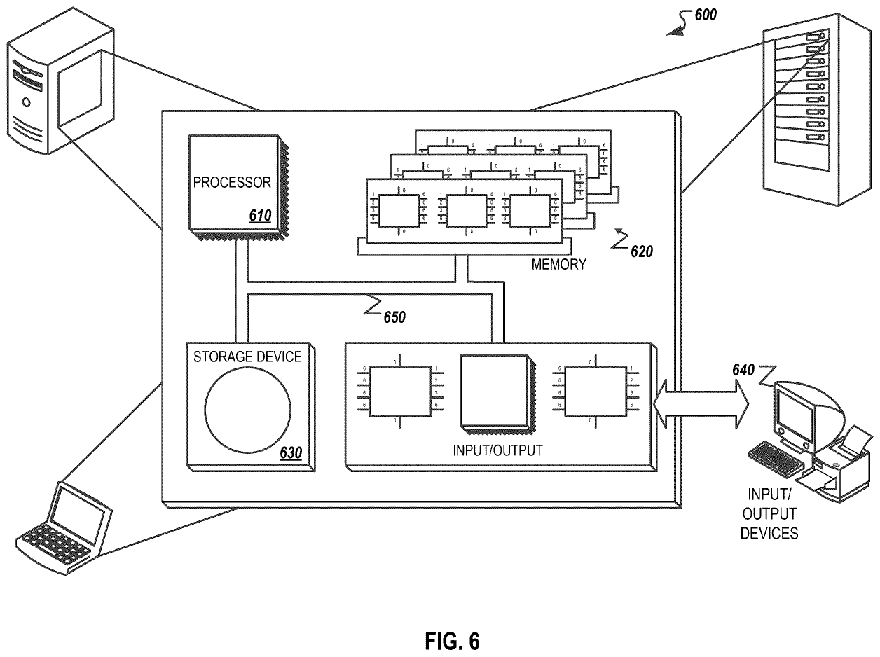

FIG. 2 is a flowchart of an example process 200 for refrigerator state detection, according to some implementations of the present disclosure. The example process 200 can be performed by any component of the example system 100, described with reference to FIGS. 1A-1C or the example computing system 600, described with reference to FIG. 6. For clarity of presentation, the description that follows generally describes the example process 200 in the context of the systems described with reference to FIGS. 1A-1C and 6 and in the context of example racks, such as described with reference to FIGS. 3A, 3B and 4A-4C.

At 202, an opening of a door of a refrigerator is detected. In some implementations, the door opening can be detected by processing door opening signals received from one or more door sensors (e.g., door sensor 120C described with reference to FIGS. 1A-1C). The door covers a front opening of the refrigerator when the door is in a closed state, as shown in FIG. 1C. The opening of the door could be detected in other ways, such as using cameras of the refrigerator that are located/oriented to capture movement of the door.

At 204, images of a frontal area of the refrigerator are recorded and/or otherwise captured. The images can be individual image captures, such as still image captures, or continuous video capture in which frames of images are sequentially captured at a specified frame rate. The frontal area is in front of the front opening of the refrigerator. The frontal area is an area where at least a portion of one of the refrigerator racks are capable of being moved into or can be accessed by a hand. The frontal area is generally within the field of view of one or more imaging devices of the refrigerator (e.g., imaging devices 118A-118C described with reference to FIGS. 1A-1C). The frontal area can be illuminated by one or more light sources (e.g., light sources 122A-122D described with reference to FIGS. 1A-1C). Recording images of a frontal area can include recording images of a particular (or given) rack moving from the interior of the refrigerator (e.g., within an outer cube perimeter defined by the frame of the refrigerator) into the frontal area, and recording images of the particular rack moving from the frontal area to the interior of the refrigerator. Each rack of the refrigerator can be movable into and out of the frontal area to facilitate the recording/capture of images of items on each of the racks.

At 206, items in the frontal area are detected. In some implementations, the items are detected using one or more frames among the images. The items can include at least a hand and/or a racked item located on one of the racks. The items in the frontal area can be detected using an item detection system (e.g., item detection system 126B described with reference to FIG. 1A), such as an object tracking engine. The object tracking engine can include an AI model trained to detect hand movement patterns and items located on one or more of the racks. The AI models can include You Only Look Once (YOLO) models, Convolutional Neural Networks (CNNs), Region-based Convolutional Neural Networks (R-CNN) models, Single Shot MultiBox Detector (SSD) models, RetinaNet models, EfficientDet models, Transformer models, MobileNet models. YOLO is a real-time object detection system that processes images in a single pass, making item detection extremely fast. Example YOLO versions include YOLOv3, YOLOv4, YOLOv5, YOLOv7. CNNs can be designed to automatically and adaptively learn spatial hierarchies of features from input images. Example CNNs include AlexNet, very deep convolutional networks, residual neural network, Inception. R-CNN models generate region proposals and then classify each region. Variants of R-CNN include Fast R-CNN and Faster R-CNN. SSD detects objects in images using a single deep neural network, processing images faster than R-CNN but with lower accuracy. Example R-CNN versions include SSD300, SSD512. RetinaNet uses a feature pyramid network (FPN) and a focal loss function to handle the class imbalance problem in item detection. EfficientDet models includes object detection models that balance accuracy and efficiency using a compound scaling method. Variants of EfficientDet models include EfficientDet-D0 to EfficientDet-D7. Transformer models can be adapted for item detection, including object detection. Examples of Transformer models include Detection Transformer and Vision Transformer. MobileNet models are designed for mobile and embedded vision applications, offering a good trade-off between speed and accuracy. Variants of MobileNet models include: MobileNetV1, MobileNetV2, and MobileNetV3

At 208, it is determined whether the detected rack is being accessed by a hand. Accessing the rack can include a hand moving in an area of a rack. Accessing the rack can include opening (or closing)based on detecting a movement direction (forward movement out of the refrigerator or backwards movement into the refrigerator) of the rack based on locations of the particular rack in two or more frames of the images. For example, in response to detecting that a given rack is in a frame, it is determined whether the given rack is being opened, closed, or if the given rack is stationary based on locations of the rack in multiple different images. The rack displacement (opening or closing) can be determined based on the velocity of the rack (as displaced distance between frames that are correlated to respective time points). For example, the difference in location of the rack in different frames can be used in conjunction with time stamps to determine the velocity and/or direction of movement of the rack.

At 210, a vertical location of the rack that is being accessed is determined. In response to determining that a rack is being opened (by detecting the rack object and determining it has a forward displacement), the vertical location of the rack (e.g., a rack identifier) is determined. The vertical location of the rack can be determined by calculating a width of a rack bounding box and using the width to determine the vertical location, by considering the configuration of the refrigerator (including distances between imaging devices and individual racks). For example, the system can generate a bounding box that corresponds to/represents the edges of the rack being opened (or closed). The dimensions of the bounding box can be measured/calculated, and the width of the bounding box can be compared to reference bounding box sizes corresponding to different racks at different vertical locations in the refrigerator. Assume for purposes of example, that the width of the rack is X pixels/inches/or some other reference unit. Further assume that rack 1 (a highest rack in the refrigerator) has a stored reference bounding box size of Z, rack 2 (a second highest rack in the refrigerator) has a stored reference bounding box size of Y, and that rack 3 (a third highest rack on the refrigerator) has a stored reference bounding box size of Z. In this example, the system can compare the measured/calculated bounding box size to each of the stored reference bounding box sizes, and determine that the measured/calculated bounding box size matches the reference bounding box size of rack 3. Based on this match, the system can determine that the rack being moved is rack 3.

At 212, a subset of imaging devices is selected for item/action detection. In some implementations, the subset of imaging devices is selected based on the vertical location of the rack. For example, a first subset of imaging devices can be selected when the vertical location of the rack indicates that the rack is within a specified distance of the imaging devices. Similarly, a second set of the imaging devices can be selected when the vertical location of the rack indicates that the rack is beyond the specified distance of the imaging devices.

In a specific example, assume that the refrigerator includes one or more ultra-wide-angle camera(s) that are focused on a top N (where N is an integer greater than zero) upper racks of the refrigerator that are closest to the cameras to capture nearer objects. Further assume that one or more standard wide-angle camera(s) (e.g., cameras that have a less-wide capture range relative to the ultra-wide cameras) are focused on the lower racks that are lower than the top N racks. Within the context example, when the system determines that vertical location of the rack being opened (or closed) is one of the top N upper racks, the system can select the one or more ultra-wide-angle cameras (rather than the standard wide-angle cameras) for item/action detection, and when the system determines that vertical location of the rack being opened (or closed) is lower than the top N upper racks, the system can select the one or more standard wide-angle cameras (rather than the ultra-wide-angle cameras) for item/action detection. In certain situations, the system can use all cameras at all times.

At 214, an action is detected based on an analysis of a hand or object (e.g., tipping a box of drinks) detected/captured over multiple frames of the images. In some implementations, in response to determining that a hand is detected in one or more of the images, the hand it is tracked across multiple frames and hand movement patterns (or actions) are classified into one of at least three states. The states of hand movement patterns can include inactive hand classification and reclassification, which can be used based on a determination that the detected hand is empty (e.g., not holding an item). The classification of an inactive hand can be made irrespective of whether the hand is detected inside or outside the rack boundary (also referred to as bounds) as represented by the bounding box of the rack. The detected hand can be classified as an active hand based on a determination that the hand is holding an item (e.g., beverage) inside or outside the rack boundary as represented by the bounding box of the rack. The detected hand can be classified as a retracting hand when it is determined that the hand is holding an item and has transitioned from inside to outside the rack bounds as represented by the bounding box of the rack. While not required, the hand can be classified as an inserting hand when the hand is determined to be holding an item and has transitioned from outside to inside the rack bounds as represented by the bounding box of the rack. In some implementations, the action detection can include determining that a new racked item has been placed on the given rack based on a reclassification of the active hand to an inactive hand, wherein a racked location of the new racked item corresponds to a location at which the active hand was reclassified as an inactive hand. Conversely, the action detection can include determining that racked items remained unmodified based on a reclassification of the inactive hand to an active hand.

In some implementations, the action detection includes item tracking in combination with (e.g., in parallel with) the hand tracking. In response to determining that a hand is in a new state for multiple consecutive frames, it is determined that a change between states occurred. The change between states is verified across multiple consecutive frames to help prevent incorrect classifications from causing errors. A hand is considered to be inside a rack if the area where the hand intersects with the rack bounding box exceeds a particular threshold. Within a session, detected items are also tracked across frames and designated either as active (an action is currently taking place on this item) or inactive (no action is currently taking place on this item). In response to determining that a hand transitions from an inactive to an active hand state at the same location as a detected item, this item is marked as active. In response to determining that an active hand enters the inactive hand state, any active item is marked as inactive, and the item's location is moved to where the hand entered the inactive hand state. The item is also added to the ‘moved items’ list. In response to determining that there are no active items when an active hand enters the inactive hand state, any newly detected items whose bounding boxes intersect with the hand's new location are added to the added items list. In response to determining that an active hand enters the hand moving away state and remains in the state past a threshold time period, or in response to determining that tracking of the hand ends, any items marked as ‘active’ are determined to be removed from the refrigerator and are added to the removed items list. Any items that have been detected within the rack's bouncing box and have not had an action performed on them are added to the unchanged items list. In some implementations, if a hand is detected approaching the edge of a rack that is not extended, and the system predicts that the hand has grabbed an item without opening the rack, the rack number is determined based on either the width of the rack edge where the hand entered or by using stereoscopic vision to estimate the hand's distance from the cameras. The X-axis location where the hand exited the rack can be used to identify which item was taken from the fridge, and optionally the length of the trajectory of the hand entering into the fridge.

At 216, two-dimensional coordinates of the racked item is projected to a corresponding location on one of the racks. The location of each item is determined, as two-dimensional coordinates, by recording the coordinates when the rack is in a stationary state. In response to determining that the rack never reaches the stationary state, the coordinates at the time point when the rack switches from an opening state to a closing state are used. The two-dimensional coordinates are extracted from processing information including the position of each item in each list relative to the bounding box of the rack and an image of each item; the bounding box of the rack in the stationary state or, if not detected, the bounding box at the point in time between the opening and closing state. In some implementations, the two-dimensional coordinates are adjusted based on individual confidence scores assigned to the items, hands, and racks detected. Any item, hand, or rack with a confidence score below a threshold is discarded. Any detected items, hands, or racks with a confidence score below, but within a small margin of the threshold can be sent to be reviewed. An overall confidence score can also be assigned to the session, known henceforth as the ‘session score.’ The ‘session score’ is calculated from the confidence score of each rack detected, known as ‘r’, the average confidence score of each action taken, known as ‘a’, and the average confidence score of each item detected, known as ‘b’. The minimum of the three inputs can be used as the session score. The session score can be classified as ‘low,’ ‘medium,’ or ‘high’ depending on the score or even more granular breaks as necessary. Scores from particular classifications can be sent for review and annotation to be used for prediction model training for subsequent item detection.

In some implementations, the projection of the two-dimensional coordinates of an item can be based, at least in part, on bounding boxes applied to the item. For example, when the item is detected, the system can generate a bounding box that encloses the item within the captured image of the item. The bounding box will have a particular width and height, and will have a reference point on the bounding box. For example, assume that the reference point for the bounding box is a corner of the bounding box that is closest to the top left corner of the bounding box of the rack on which the item is placed. In this example, the height and width of the bounding box of the item will define the area of the rack occupied by the item, and the reference point of the bounding bod of the item will define the orientation of the item relative to the top left corner of the bounding box of the rack on which the item is placed.

At 218, a three-dimensional representation of current contents of the refrigerator is generated based on the corresponding location and a vertical location of the one of the racks. The current contents of the refrigerator include a list of items and respective item positions that are detected. To generate the three-dimensional representation of a racked item, the two-dimensional coordinates of the location of the racked item are used to represent the location on the rack, while the vertical location of the rack (e.g., rack number) on which the item is placed can be used as the third-dimension for the three-dimensional representation of the location of the item. For example, assume that the detected two-dimensional location of an item is X=30 pixels, and Y=10 pixels (e.g., from a reference location of X=0 pixels and Y=0 pixels) in a captured image of the item on a rack. Further assume that the vertical location of the item is on rack 2. In this example, the three-dimensional representation of the location of the item can be X=30, Y=10, and Z=2. This enables the system to accurately determine the three-dimensional location of the item within the refrigerator.

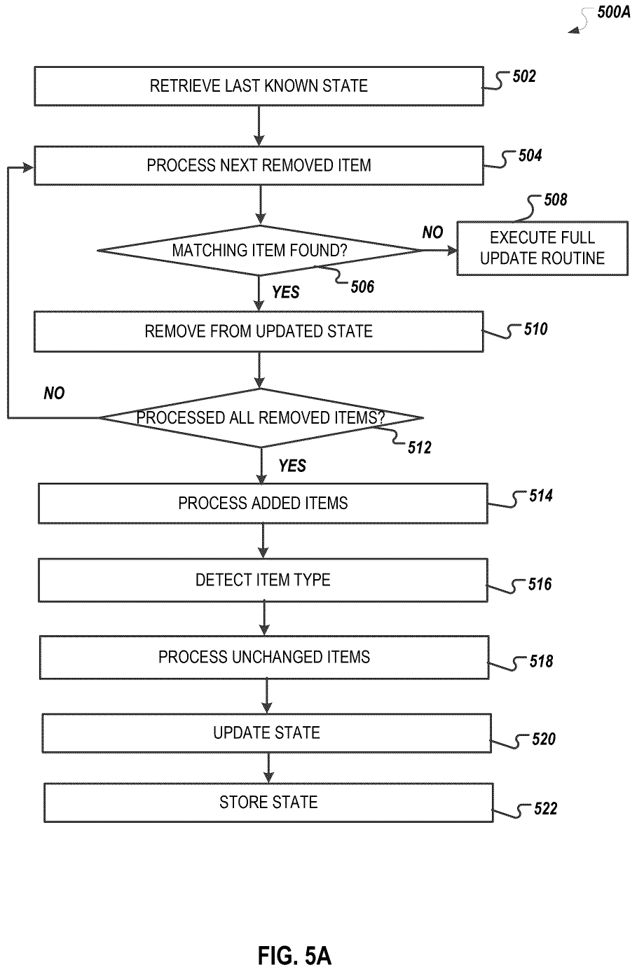

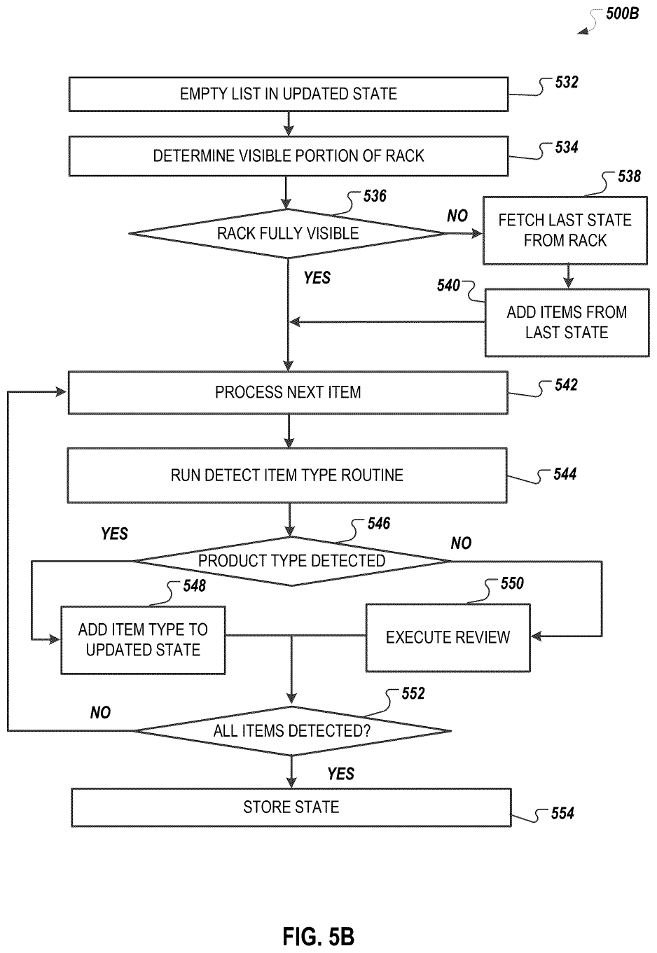

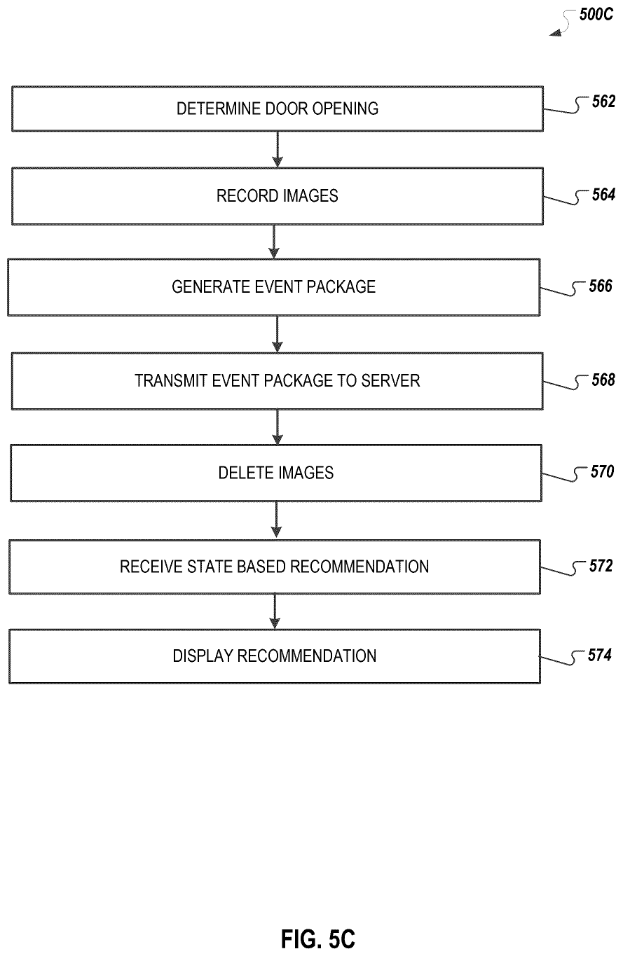

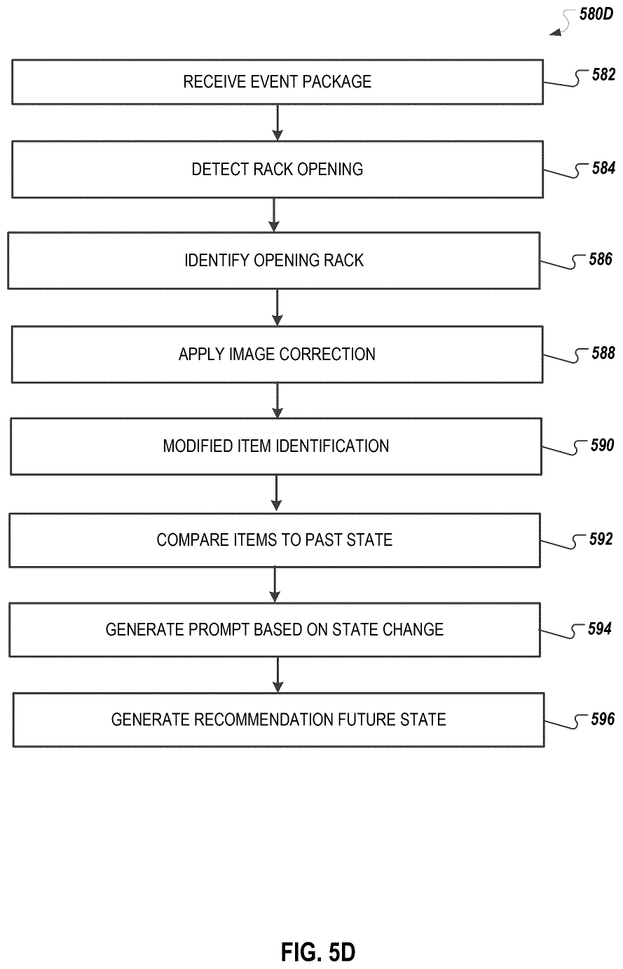

At 220, a current state of the refrigerator is updated based on changes (delta) between the three-dimensional representation of the current contents and a previously generated three-dimensional representation of previous contents of the refrigerator, as described in detail with reference to process described with reference to FIG. 5A. The current contents include all items determined to be currently stored in the refrigerator. In some implementations in response to updating the current state of the refrigerator, an automatic action is triggered. The automatic action that can be triggered based on the updated state of the refrigerator can include a temperature control adjustment, a humidity control adjustment, a light or a door alarm initiation or generation of an alert to be displayed by a GUI (e.g., GUI 116, described with reference to FIGS. 1A-1C). The temperature control can include transmission of a signal to a thermostat of the refrigerator to automatically adjust the cooling based on the internal temperature. For example, if the updated state of the refrigerator indicates that the refrigerator is empty, the temperature can be decreased below a set point, and the compressor is shut down. The humidity can be adjusted to set humidity levels in different compartments to keep items fresh longer or to minimize energy consumption. The light and door alarms can be triggered to indicate a modification of a refrigerator parameter (e.g., adjustment of the internal temperature and save energy). The alert to be displayed by a GUI can be transmitted using a secured network connectivity. For example, the refrigerators can connect to Wi-Fi and can transmit a signal to a remote user device to display alerts, to facilitate state monitoring, to adjust settings remotely, and even provide recommendations (e.g., recipes or item supply adjustment) based on the currently updated contents.

FIG. 3A is an example

visual representation 300A of an example rack 302 with items 304A-304C before distortion correction, according to some implementations of the present disclosure. The example visual representation 300A can include image distortions 306A, 306B due to a distance between the imaging device that captured the example visual representation 300A and the imaged example rack 302. The perspective distortion affects how the example rack 302 appears in the example visual representation 300A. In the illustrated example, the visual representation 300A includes barrel distortions that make straight line portions of the example rack 302 to appear curved outward from the center of the rack 302. The image distortions 306A, 306B can hinder the ability to accurately determine positions of the items 304A-304C stored within the example rack 302. For example, the image distortions can alter the labels 308A-308C of the items and/or the shape of the items, minimizing the ability of an item detection engine to accurately identify items.

One or more distortion correction methods can be applied. Distortion correction methods can include radial basis function mapping, polynomial distortion models, deep learning-based methods, deconvolution algorithms, or image registration algorithms. The radial basis function mapping method uses radial basis functions to map and correct distortions. The polynomial distortion models use polynomial equations to correct radial and tangential distortions. The deep learning-based methods apply deep learning algorithms to correct various types of geometric distortions. The deep learning-based methods can process rack images including complex and mixed distortions by learning from previously collected datasets. The image registration algorithms can be used to align and correct rack images by matching features (e.g., bounding box or frame structure) within the image. The distortion correction algorithms can be implemented to increase item detection precision by correcting optical distortions.

FIG. 3B is an example visual representation 300B of an example rack 302 with items 304A-304C after distortion correction, according to some implementations of the present disclosure. The example visual representation 300A can include corrected image distortions 306A, 306B that align the representation of the features of the example rack 302 within the example visual representation 300B with a physical representation of the features of the example rack 302. In the illustrated example, the visual representation 300B includes corrected barrel distortions to match the physical representation of the rack 302. The corrected image distortions 308A, 308B facilitate accurate identification of positions of the items 304A-304C stored within the example rack 302. While FIGS. 3A and 3B illustrate a type of distortion correction, in some implementations, multiple stages of correction occur, for example correction applied to the full image (full rack) followed by correction applied to one or more sub-images (e.g., individuals cans and bottles).

FIG. 4A is a block diagram 400A of an example rack representation 402 created for refrigerator state detection, according to some implementations of the present disclosure. The example rack representation 402 can include multiple virtual and/or physically delineated sections 402A-402E configured to store one or more items 404A-404E. The delineated sections 402A-402E of the example rack 402 are surrounded by a rack bounding box 406 that represents the perimeter of the rack on which the items 404A-404E are located. The size (e.g., width) of the bounding box 406 is calculated and/or measured, and used to predict/determine which physical rack (e.g., by way of a rack number) of the refrigerator is being represented by the rack representation 402. For example, the bounding box of a rack closer to the cameras can generally be wider than the bounding box of a physical rack further from the camera. Once the physical rack is identified, the camera used to perform item detection can be selected. In some implementations, when the rack detected is one of the upper racks (e.g., closer to the cameras), an ultra-wide camera(s) can be used for item and/or action detection. If the rack is one of the lower racks (e.g., specified numbers, such as three, that are furthest from the cameras), data from a higher-resolution single standard wide-angle camera can be collected and utilized to focus on the lower racks. The cameras can be set to image one or more racks that are fully or partly extended or completely retracted. In some implementations, the field of view of the camera is set to be optimized for taking images of the outer-most objects of the bounding box (e.g., the corners farthest from the cameras when the shelf is fully extended), the cameras being the closest to the respective outer corners when the drawers are closed. The items 404A-404E can have similar or different geometries, weights, and exterior characteristics (e.g., reflectance value, label patters, color contrast, etc.).

FIG. 4B is a block diagram 400B of the example rack 402 with items 404A-404C detected after an action modifying a previous state of the example rack 402, according to some implementations of the present disclosure. The block diagram 400B of the example rack 402 can include projected locations 408A, 408B, 408C of the items 404A, 404C, and 404D, respectively, which are detected after an action (e.g., removal of items from the example rack 402) modifying a previous state of the example rack 402. More specifically, in this view, the can 404B and the bottle 404E shown in FIG. 4A have been removed from the rack 402 in FIG. 4B.

FIG. 4C is a block diagram 400C of an example rack 402 with items 404A-404C detected after image correction, according to some implementations of the present disclosure. The block diagram 400C of the example rack 402 can include corrected locations 410A, 410B, 410C of the items 404A-404C detected after image correction (e.g., distortion removal) modifying the original image of the example rack 402A.

FIG. 5A is a flowchart of an example process 500A for refrigerator state detection, according to some implementations of the present disclosure. The example process 500A can be performed by any component of the example system 100, described with reference to FIGS. 1A-1C or the example computing system 600, described with reference to FIG. 6. For clarity of presentation, the description that follows generally describes the example process 500A in the context of the systems described with reference to FIGS. 1A-1C and 6 and in the context of example racks, such as described with reference to FIGS. 3A, 3B and 4A-4C.

At 502, a last known state (inventory and refrigerator parameters) of a refrigerator is retrieved, by one or more processors (e.g.,110B, as described with reference to FIGS. 1A-1C), from a memory (e.g., memory 112B of server system, as described with reference to FIGS. 1A-1C). For example, a copy of the last known inventory can be created to be updated based on detected actions, as described with reference to FIGS. 4A-4C.

At 504, a next removed item is processed, by the one or more processors. Each item in a removed items list is iteratively selected to be processed.

At 506, for each item in a removed items list, it is determined whether a matching item exists in the last known inventory at the same X and Y coordinates and with the same size and aspect (within a tolerance threshold). Any item that is within the tolerance threshold is referred to as a ‘match’. In some implementations, embeddings (a vector representation of the item within the frame) can also be used to compare the items identified in collected images and previously identified items.

At 508, in response to determining that a match is absent, the delta update routine is terminated and replaced by an execution of a full update routine. In some implementations, in response to determining that a match is absent, the list of items is processed as a new detection.

At 510, in response to determining that a match is found, the respective item is removed from the new inventory.

At 512, it is determined whether all removed items are processed. In response to determining that the removed items list includes unprocessed items, the process 500A processes the next removed item (at 504).

At 514, in response to determining that all removed items are processed, added items are processed. For each item that was added to the refrigerator, the detect item routine is executed based on detected actions, as described with reference to FIGS. 4A-4C. If an item is determined to be placed on a rack, the respective item is added to the new inventory list, along with the item's location on the rack.

At 516, each added item can be processed to detect an item type. In some implementations, item type identification can include processing images of the item to extract item features (e.g., edge detection, color analysis, text and shape analysis) and to perform object detection using a pre-trained AI model (e.g., CNN model) to detect and to classify different type of items (e.g., type of beverage recipient) based on a comparison with known item types stored in and retrieved from a memory. In some implementations, the item type identification can include performing a match between data (e.g., printed weight or volume) extracted from a label of the item and sensor data (e.g., measured weight). In response to determining that no match is found, a placeholder item can be added to the new inventory and the item is sent, to a user device, for additional review. The storage of the placeholder item can trigger an alert to display on a GUI to end users that the item was not recognized.

At 518, unchanged items are processed. For each unchanged item, it is determined that the new inventory includes an item at a similar location, size, and aspect ratio. In response to determining that matches are absent, at the location for the unchanged item, the full update routine is executed, as described with reference to FIG. 5B.

At 520, in response to determining that all items were processed, the state is being marked as being updated. In response to determining that the processed images include any items in the inventory that are on the visible portion of the rack and have not been detected, the full update routine is executed, as described with reference to FIG. 5B.

At 522, the updated state can be transmitted by the processors, to a memory (database) for storage.

FIG. 5B is a flowchart of an example process 500B for refrigerator state detecting, according to some implementations of the present disclosure. The example process 500B can be performed by any component of the example system 100, described with reference to FIGS. 1A-1C or the example computing system 600, described with reference to FIG. 6. For clarity of presentation, the description that follows generally describes the example process 500B in the context of the systems described with reference to FIGS. 1A-1C and 6 and in the context of example racks, such as described with reference to FIGS. 3A, 3B and 4A-4C.

At 532, a list of items of an updated state, stored in a memory (database), is emptied to generate a blank list of items.

At 534, a visible portion of a rack is determined by processing collected images of the rack. The width and height of the rack's bounding box is extracted and compared to known aspect ratios of the rack, to determine a proportion of the rack that is visible.

At 536, it is determined, by comparing the proportion of the rack that is visible to a respective threshold, whether the entire rack is visible.

At 538, in response to determining that part of the rack is hidden, the last known state of the rack is retrieved from the memory. At 540, any items that are outside of the visible rack area are added to the updated state.

At 542, each detected item is being iteratively processed.

At 544, for each detected item on the rack, the item detection routine is executed, as described with reference to FIGS. 4A-4C. In response to determining that an item is placed on the rack, the item is selected to be added to the updated state, along with the item's location on the rack.

At 546, it is determined whether the item type is identifiable and matches a known item type, according to item classes stored in the memory.

At 548, in response to determining that an item type match is found, the item type and item's location on the rack are added to the updated state.

At 550, in response to determining that no match is found, a placeholder item is added to the updated state with the respective item location on the rack. The picture of the placeholder item is processed to be sent for review. The picture of the placeholder item can be cropped to the bounds of the detected item to exclude any other nearby items. A vector representation of the cropped frame is generated. A nearest neighbor lookup of the vector representation is performed in the embeddings database to find the closest matches. If a match is found above a given threshold the result with the highest score is returned to the parent routine. If multiple matches are found above the threshold with similar scores, for example several items with the same packaging design in different volumes, the estimated size of the item calculated in the item projection routine can be used to estimate the volume of the container to further improve the prediction. If no match is found above the threshold, the image can be sent for further verification. Once identified, the image's embeddings and its item identifier can be added to the database of known items. The review results are used to update the known item type classes in the memory and the identified item type is added to the updated state.

At 552, in response to determining that all items were processed, the state is being marked as being updated.

At 554, the updated state can be transmitted by the processors, to a memory (database) for storage.

FIG. 5C is a flowchart of an example process 500C for refrigerator state detecting, according to some implementations of the present disclosure. The example process 500C can be performed by a refrigerator 102, described with reference to FIGS. 1A-1C. For clarity of presentation, the description that follows generally describes the example process 500C in the context of the systems described with reference to FIGS. 1A-1C and 6 and in the context of example racks, such as described with reference to FIGS. 3A, 3B and 4A-4C.

At 562, it is determined, by a processor, based on received door sensor signals, that a refrigerator door is opening exposing of a frontal area that is in front of an opening of the refrigerator.

At 564, imaging devices are activated, by the processor, to acquire images of a frontal area that is in the front of the front opening of the refrigerator.

At 566, an event package is generated, by the processor. The event package includes the collected images, metadata associated with the collected images, and sensor signals. In some implementations, the event package includes information about an upcoming event defining a target availability of items within the refrigerator at a future time point.

At 568, the event package is transmitted, by the processor, to a server system (e.g., server system 104, described with reference to FIGS. 1A-1C). The server system processes the event package to generate a current state of the refrigerator including an updated state. The server system uses the current state of the refrigerator to generate a recommendation.

At 570, in response to determining successful transmission of the event package, to the server system, the event package stored a memory of the refrigerator is deleted for restoring memory storage.

At 572, a state-based recommendation is received, by the processor. The recommendation include a proposed modification of the state relative to past state trends. In some implementations, the recommendation is adjusted based on an upcoming event.

At 574, the received recommendation is displayed, by the GUI (e.g., GUI 116 described with reference to FIGS. 1A-1C). The recommendation can include a graphical content defining a representation of the items to be added to the refrigerator, each displayed item being annotated with a recommended quantity. The graphical content can be displayed by the GUI of the refrigerator. In some examples, the graphical representation can be provided as a web-based rendering using a web rendering runtime that is built into the popover container (e.g., iframe). In some examples, the graphical representation is compatible with a UI framework of the popover container. The recommendation can be displayed as a set of recommendations or instructions for updating the state.

FIG. 5D is a flowchart of an example process 500D for refrigerator state detecting, according to some implementations of the present disclosure. The example process 500D can be performed by any component of the server system 104, described with reference to FIGS. 1A-1C or the example computing system 600, described with reference to FIG. 6. For clarity of presentation, the description that follows generally describes the example process 500D in the context of the systems described with reference to FIGS. 1A-1C and 6 and in the context of example racks, such as described with reference to FIGS. 3A, 3B and 4A-4C.

At 582, an event package is received with a request to perform refrigerator state detection for a refrigerator, by the server system, from the refrigerator. The event package includes a refrigerator identifier, collected images, metadata associated with the collected images (including time stamps of image collection and configurations of imaging devices), and sensor signals (e.g., rack weights measured during image acquisition). The images can be received as a video stream with a known frame rate. In some implementations, the event package includes information about an upcoming event defining a target availability of items within the refrigerator at a future time point.

At 584, the collected images are processed to detect a rack opening by tracking a displacement of a rack bounding box between the frames.

At 586, the opening rack is identified based on a thickness of the bounding box relative to a distance from the imaging devices. In some implementations, the opening rack is identified using a rack identifier that can be visible in the collected images. The identification of the opening rack can include an identification of a vertical location of the rack.

At 588, image correction is applied to correct distortions, using the configurations of imaging devices. The generated corrected images include at least a portion of the bounding box represented according to a physical geometry of the bounding box.

At 590, modified items in the tracked rack are identified. The modified item identification includes extraction of locations of modified items in the tracked rack and item type identification. Item location extraction can be filtered based on detected hand action patterns, using a prediction model. A detected hand can be tracked across multiple frames and hand movement patterns are classified to label actives, for which the location is determined relative to the bounding box and the vertical location of the rack. In some implementations, the locations of modified items in the tracked rack can be indicated relative to sections of the rack, as described with reference to FIGS. 4A-4C.

At 592, the modified items are used to update the state of the refrigerator. The modified items are compared to items within a past state of the refrigerator, retrieved from a memory, using the refrigerator identifier and a time stamp, to facilitate a selection of a most recent previous state of the respective refrigerator. The comparison can be based on item type and item location. In some implementations, the comparison can include embeddings matching. Each item can have one or more entries in the embeddings database, for example, to store images of the item from multiple angles, under different lighting conditions, and to account for variations in item packaging to facilitate accurate item comparison. The embeddings matching can include a similarity search for the set of embeddings. For each compared embeddings, similarity can be measured using a suitable similarity metric, such a cosine similarity or Euclidean distance, computed in the embedding space. Items can be determined to match if the similarity metric exceeds a set threshold.

At 594, a prompt is generated based on a state change, for a prediction model. The prompt can be generated as a text, using the descriptions of the updated state, a refrigerator context, and a prompt template. The prompt can include a request to generate a plan to modify current items listed in the updated state, based on state trends, and upcoming events provided as context. In some implementations, the prompt is validated, by the processor, by processing the one or more textual requirements. Validation of the prompt by processing the one or more textual requirements includes a verification of a match between the updated state, and state trends and context requirements according to fields of the prompt template. The validation can be executed according to one or more conditions defining a minimum number of item requirements to be included to enable processing of the request.

At 596, a recommendation for a future state is generated, by the prediction model, and transmitted to the refrigerator. The prediction model can include an artificial intelligence model, such as large language models (e.g., deep learning models) trained using state trends mapped to events. The prediction model can be trained, including an adjustment of weights according to different refrigerator types, for refrigerator state detection. The recommendation can include a list of item types and quantities to be added to the refrigerator within a time interval.

The example processes 200, 500A, 500B, 500C, 500D for refrigerator state detection provides an advantage of accurately updating a current state of a refrigerator, while conserving system resources. The described example processes 200, 500A, 500B, 500C, 500D for refrigerator state detection contextualizing the prediction models with relevant sensor and event data, which enhances the accuracy of item identification for state adjustment plans for refrigerators with similar state trends. The described example processes 200, 500A, 500B, 500C, 500D integrate a deeper understanding of state trends relative to current contents, enabling prediction models to tailor recommendations and generate optimized item identification and recommendation generation based on training. The example processes 200, 500A, 500B, 500C, 500D are applicable to multiple refrigerator types and/or versions to provide a thorough assessment of contents for the requested refrigerator state detection.

FIG. 6 is a block diagram of an example computing system 600 used to provide computational functionalities associated with described algorithms, methods, functions, processes, flows, and procedures, according to some implementations of the present disclosure. As shown in FIG. 6, the computing system 600 can include a processor 610, a memory 620, a storage device 630, and input/output devices 640. The processor 610, the memory 620, the storage device 630, and the input/output devices 640 can be interconnected using a system bus 650. The processor 610 is capable of processing instructions for execution within the computing system 600. Such executed instructions can implement one or more components of, for example, the refrigerator state detection system 124, described with reference to FIGS. 1A-1C. In some implementations of the current subject matter, the processor 610 can be a single-threaded processor. Alternately, the processor 610 can be a multi-threaded processor. The processor 610 is capable of processing instructions stored in the memory 620 and/or on the storage device 630 to display graphical information for a user interface provided using the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a floppy disk device, solid state drive, a hard disk device, an optical disk device, or a tape device, or other suitable persistent storage means. The input/output device 640 provides input/output operations for the computing system 600. In some implementations of the current subject matter, the input/output device 640 includes a keyboard and/or pointing device. In various implementations, the input/output device 640 includes a display unit for displaying graphical user interfaces.

According to some implementations of the current subject matter, the input/output device 640 can provide input/output operations for a network device. For example, the input/output device 640 can include Ethernet ports or other networking ports to communicate with one or more wired and/or wireless networks (e.g., a LAN, a WAN, the Internet).

In some implementations of the current subject matter, the computing system 600 can be used to execute various interactive computer software applications that can be used for organization, analysis and/or storage of data in various (e.g., tabular) format (e.g., Microsoft Excel®, and/or any other type of software). Alternatively, the computing system 600 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities or can be standalone computing products and/or functionalities. Upon activation within the applications, the functionalities can be used to generate the user interface provided using the input/output device 640. The user interface can be generated and presented to a user by the computing system 600 (e.g., on a computer screen detect).

One or more aspects or features of the subject matter described herein can be realized in digital electronic circuitry, integrated circuitry, specially designed ASICs, FPGAs computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) detect for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) can contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes can take place simultaneously, concurrently, in parallel, and/or in different orders than as shown. Moreover, processes can have additional operations, fewer operations, and/or different operations and location where operation occurs (e.g., moving from cloud or server to user device processing), so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

### Example 1

A method, comprising: detecting an opening of a door of a refrigerator, wherein the door covers a front opening of the refrigerator when the door is in a closed state; recording, by a set of imaging devices, images of a frontal area that is in front of the front opening of the refrigerator; detecting, based on the images, items in the frontal area, wherein the items comprise at least a hand and a racked item located on one of the racks; projecting two-dimensional coordinates of the racked item to a corresponding location on the one of the racks; generating a three-dimensional representation of current contents of the refrigerator based on the corresponding location and a vertical location of the one of the racks; and updating a current state of the refrigerator based on changes between the three-dimensional representation of the current contents and a previously generated three-dimensional representation of previous contents of the refrigerator.

### Example 2

The method the preceding example, wherein; recording images of a frontal area comprises recording images of a given rack moving from inside the refrigerator into the frontal area; detecting items in the frontal area comprises detecting the given rack in a frame among the images; the method further comprises determining that the given rack is being opened based on detecting forward movement of the rack based on locations of the given rack in two or more of the images; and determining the vertical location of the given rack based on a width of a bounding box used to surround the given rack in the images.

### Example 3

The method of any of the preceding examples, further comprising selecting a subset of the imaging devices to be used for action detection based on the vertical location of the given rack, wherein a first subset of the imaging devices is selected when the vertical location of the given rack indicates that the given rack is within a specified distance of the imaging devices, and a second subset of the imaging devices is selected when the vertical location of the given rack indicates that the given rack is beyond the specified distance of the imaging devices.

### Example 4

The method of any of the preceding examples, further comprising performing the action detection based on an analysis of the hand over multiple frames of the images.

### Example 5

The method of any of the preceding examples, wherein performing the action detection comprises classifying the hand as one of an inactive hand, an active hand, or a retracting hand.

### Example 6

The method of any of the preceding examples, wherein: classifying the hand as the inactive hand comprises classifying the hand as the inactive hand based on a determination that the hand is not holding the racked item; classifying the hand as an active hand comprises classifying the hand as an active hand based on a determination that the hand is holding the racked item inside a boundary of the given rack; and classifying the hand as a retracting hand comprises classifying the hand as a retracting hand based on a determination that the hand is holding the racked item and has transitioned from a first location that is inside a boundary of the given rack to a second location that is outside a boundary of the given rack.

### Example 7

The method of any of the preceding examples, further comprising determining that a new racked item has been placed on the given rack based on a reclassification of the active hand to the inactive hand, wherein a racked location of the new racked item corresponds to a location at which the active hand was reclassified as the inactive hand.

### Example 8

The method of any of the preceding examples, wherein updating the current state of the refrigerator comprises including the new racked item in a list of items located on the given rack.

### Example 9

A system comprising: a computing device; and a computer-readable storage device coupled to the computing device and having instructions stored thereon which, when executed by the computing device, cause the computing device to perform operations for selectively generating graphical representations with digital assistants in enterprise systems, the operations comprising: detecting an opening of a door of a refrigerator, wherein the door covers a front opening of the refrigerator when the door is in a closed state; recording, by a set of imaging devices, images of a frontal area that is in front of the front opening of the refrigerator; detecting, based on the images, items in the frontal area, wherein the items comprise at least a hand and a racked item located on one of the racks; projecting two-dimensional coordinates of the racked item to a corresponding location on the one of the racks; generating a three-dimensional representation of current contents of the refrigerator based on the corresponding location and a vertical location of the one of the racks; and updating a current state of the refrigerator based on changes between the three-dimensional representation of the current contents and a previously generated three-dimensional representation of previous contents of the refrigerator.

### Example 10

The system of the preceding example, wherein; recording images of a frontal area comprises recording images of a given rack moving from inside the refrigerator into the frontal area; detecting items in the frontal area comprises detecting the given rack in a frame among the images; the system further comprises determining that the given rack is being opened based on detecting forward movement of the rack based on locations of the given rack in two or more of the images; and determining the vertical location of the given rack based on a width of a bounding box used to surround the given rack in the images.

### Example 11

The system of any of the preceding examples, wherein the operations comprise selecting a subset of the imaging devices to be used for action detection based on the vertical location of the given rack, wherein a first subset of the imaging devices is selected when the vertical location of the given rack indicates that the given rack is within a specified distance of the imaging devices, and a second subset of the imaging devices is selected when the vertical location of the given rack indicates that the given rack is beyond the specified distance of the imaging devices.

### Example 12

The system of any of the preceding examples, wherein the operations comprise performing the action detection based on an analysis of the hand over multiple frames of the images.

### Example 13

The system of any of the preceding examples, wherein performing the action detection comprises classifying the hand as one of an inactive hand, an active hand, or a retracting hand.

### Example 14

The system of any of the preceding examples, wherein: classifying the hand as the inactive hand comprises classifying the hand as the inactive hand based on a determination that the hand is not holding the racked item; classifying the hand as an active hand comprises classifying the hand as an active hand based on a determination that the hand is holding the racked item inside a boundary of the given rack; and classifying the hand as a retracting hand comprises classifying the hand as a retracting hand based on a determination that the hand is holding the racked item and has transitioned from a first location that is inside a boundary of the given rack to a second location that is outside a boundary of the given rack.

### Example 15

The system of any of the preceding examples, wherein the operations comprise determining that a new racked item has been placed on the given rack based on a reclassification of the active hand to the inactive hand, wherein a racked location of the new racked item corresponds to a location at which the active hand was reclassified as the inactive hand.

### Example 16

The system of any of the preceding examples, wherein updating the current state of the refrigerator comprises including the new racked item in a list of items located on the given rack.

### Example 17

A non-transitory computer-readable media encoded with a computer program, the computer program comprising instructions that when executed by one or more computers cause the one or more computers to perform operations comprising: detecting an opening of a door of a refrigerator, wherein the door covers a front opening of the refrigerator when the door is in a closed state; recording, by a set of imaging devices, images of a frontal area that is in front of the front opening of the refrigerator; detecting, based on the images, items in the frontal area, wherein the items comprise at least a hand and a racked item located on one of the racks; projecting two-dimensional coordinates of the racked item to a corresponding location on the one of the racks; generating a three-dimensional representation of current contents of the refrigerator based on the corresponding location and a vertical location of the one of the racks; and updating a current state of the refrigerator based on changes between the three-dimensional representation of the current contents and a previously generated three-dimensional representation of previous contents of the refrigerator.

### Example 18

The non-transitory computer-readable media of the preceding example, wherein; recording images of a frontal area comprises recording images of a given rack moving from inside the refrigerator into the frontal area; detecting items in the frontal area comprises detecting the given rack in a frame among the images; the non-transitory computer-readable media further comprises determining that the given rack is being opened based on detecting forward movement of the rack based on locations of the given rack in two or more of the images; and determining the vertical location of the given rack based on a width of a bounding box used to surround the given rack in the images.

### Example 19

The non-transitory computer-readable media of any of the preceding examples, wherein the operations comprise selecting a subset of the imaging devices to be used for action detection based on the vertical location of the given rack, wherein a first subset of the imaging devices is selected when the vertical location of the given rack indicates that the given rack is within a specified distance of the imaging devices, and a second subset of the imaging devices is selected when the vertical location of the given rack indicates that the given rack is beyond the specified distance of the imaging devices, wherein the operations comprise performing the action detection based on an analysis of the hand over multiple frames of the images.

### Example 20

The non-transitory computer-readable media of any of the preceding examples, wherein performing the action detection comprises classifying the hand as one of an inactive hand, an active hand, or a retracting hand and wherein: classifying the hand as the inactive hand comprises classifying the hand as the inactive hand based on a determination that the hand is not holding the racked item; classifying the hand as an active hand comprises classifying the hand as an active hand based on a determination that the hand is holding the racked item inside a boundary of the given rack; and classifying the hand as a retracting hand comprises classifying the hand as a retracting hand based on a determination that the hand is holding the racked item and has transitioned from a first location that is inside a boundary of the given rack to a second location that is outside a boundary of the given rack.

What is claimed is:

1. A method, comprising:
detecting an opening of a door of a refrigerator, wherein the door covers a front opening of the refrigerator when the door is in a closed state;
recording, by a set of imaging devices, images of a frontal area that is in front of the front opening of the refrigerator;
detecting, based on the images, items in the frontal area, wherein the items comprise at least a hand and a racked item located on one of the racks;
projecting two-dimensional coordinates of the racked item to a corresponding location on the one of the racks;
generating a three-dimensional representation of current contents of the refrigerator based on the corresponding location and a vertical location of the one of the racks; and
updating a current state of the refrigerator based on changes between the three-dimensional representation of the current contents and a previously generated three-dimensional representation of previous contents of the refrigerator.

2. The method of claim 1, wherein;
recording images of a frontal area comprises recording images of a given rack moving from inside the refrigerator into the frontal area;
detecting items in the frontal area comprises detecting the given rack in a frame among the images;
the method further comprises determining that the given rack is being opened based on detecting forward movement of the rack based on locations of the given rack in two or more of the images; and
determining the vertical location of the given rack based on a width of a bounding box used to surround the given rack in the images.

3. The method of claim 2, further comprising selecting a subset of the imaging devices to be used for action detection based on the vertical location of the given rack, wherein a first subset of the imaging devices is selected when the vertical location of the given rack indicates that the given rack is within a specified distance of the imaging devices, and a second subset of the imaging devices is selected when the vertical location of the given rack indicates that the given rack is beyond the specified distance of the imaging devices.

4. The method of claim 3, further comprising performing the action detection based on an analysis of the hand over multiple frames of the images.

5. The method of claim 2, wherein performing the action detection comprises classifying the hand as one of an inactive hand, an active hand, or a retracting hand.

6. The method of claim 5, wherein:
classifying the hand as the inactive hand comprises classifying the hand as the inactive hand based on a determination that the hand is not holding the racked item;
classifying the hand as an active hand comprises classifying the hand as an active hand based on a determination that the hand is holding the racked item inside a boundary of the given rack; and
classifying the hand as a retracting hand comprises classifying the hand as a retracting hand based on a determination that the hand is holding the racked item and has transitioned from a first location that is inside a boundary of the given rack to a second location that is outside a boundary of the given rack.

7. The method of claim 6, further comprising determining that a new racked item has been placed on the given rack based on a reclassification of the active hand to the inactive hand, wherein a racked location of the new racked item corresponds to a location at which the active hand was reclassified as the inactive hand.

8. The method of claim 2, wherein updating the current state of the refrigerator comprises including the new racked item in a list of items located on the given rack.

9. A system comprising:
a computing device; and
a computer-readable storage device coupled to the computing device and having instructions stored thereon which, when executed by the computing device, cause the computing device to perform operations for selectively generating graphical representations with digital assistants in enterprise systems, the operations comprising:
detecting an opening of a door of a refrigerator, wherein the door covers a front opening of the refrigerator when the door is in a closed state;
recording, by a set of imaging devices, images of a frontal area that is in front of the front opening of the refrigerator;
detecting, based on the images, items in the frontal area, wherein the items comprise at least a hand and a racked item located on one of the racks;
projecting two-dimensional coordinates of the racked item to a corresponding location on the one of the racks;
generating a three-dimensional representation of current contents of the refrigerator based on the corresponding location and a vertical location of the one of the racks; and
updating a current state of the refrigerator based on changes between the three-dimensional representation of the current contents and a previously generated three-dimensional representation of previous contents of the refrigerator.

10. The system of claim 9, wherein;
recording images of a frontal area comprises recording images of a given rack moving from inside the refrigerator into the frontal area;
detecting items in the frontal area comprises detecting the given rack in a frame among the images;
the system further comprises determining that the given rack is being opened based on detecting forward movement of the rack based on locations of the given rack in two or more of the images; and
determining the vertical location of the given rack based on a width of a bounding box used to surround the given rack in the images.

11. The system of claim 10, wherein the operations comprise selecting a subset of the imaging devices to be used for action detection based on the vertical location of the given rack, wherein a first subset of the imaging devices is selected when the vertical location of the given rack indicates that the given rack is within a specified distance of the imaging devices, and a second subset of the imaging devices is selected when the vertical location of the given rack indicates that the given rack is beyond the specified distance of the imaging devices.

12. The system of claim 11, wherein the operations comprise performing the action detection based on an analysis of the hand over multiple frames of the images.

13. The system of claim 10, wherein performing the action detection comprises classifying the hand as one of an inactive hand, an active hand, or a retracting hand.

14. The system of claim 13, wherein:
classifying the hand as the inactive hand comprises classifying the hand as the inactive hand based on a determination that the hand is not holding the racked item;
classifying the hand as an active hand comprises classifying the hand as an active hand based on a determination that the hand is holding the racked item inside a boundary of the given rack; and
classifying the hand as a retracting hand comprises classifying the hand as a retracting hand based on a determination that the hand is holding the racked item and has transitioned from a first location that is inside a boundary of the given rack to a second location that is outside a boundary of the given rack.

15. The system of claim 14, wherein the operations comprise determining that a new racked item has been placed on the given rack based on a reclassification of the active hand to the inactive hand, wherein a racked location of the new racked item corresponds to a location at which the active hand was reclassified as the inactive hand.

16. The system of claim 10, wherein updating the current state of the refrigerator comprises including the new racked item in a list of items located on the given rack.

17. A non-transitory computer-readable media encoded with a computer program, the computer program comprising instructions that when executed by one or more computers cause the one or more computers to perform operations comprising:
detecting an opening of a door of a refrigerator, wherein the door covers a front opening of the refrigerator when the door is in a closed state;
recording, by a set of imaging devices, images of a frontal area that is in front of the front opening of the refrigerator;
detecting, based on the images, items in the frontal area, wherein the items comprise at least a hand and a racked item located on one of the racks;
projecting two-dimensional coordinates of the racked item to a corresponding location on the one of the racks;
generating a three-dimensional representation of current contents of the refrigerator based on the corresponding location and a vertical location of the one of the racks; and
updating a current state of the refrigerator based on changes between the three-dimensional representation of the current contents and a previously generated three-dimensional representation of previous contents of the refrigerator.

18. The non-transitory computer-readable media of claim 17, wherein;
recording images of a frontal area comprises recording images of a given rack moving from inside the refrigerator into the frontal area;
detecting items in the frontal area comprises detecting the given rack in a frame among the images;
the non-transitory computer-readable media further comprises determining that the given rack is being opened based on detecting forward movement of the rack based on locations of the given rack in two or more of the images; and
determining the vertical location of the given rack based on a width of a bounding box used to surround the given rack in the images.

19. The non-transitory computer-readable media of claim 18, wherein the operations comprise selecting a subset of the imaging devices to be used for action detection based on the vertical location of the given rack, wherein a first subset of the imaging devices is selected when the vertical location of the given rack indicates that the given rack is within a specified distance of the imaging devices, and a second subset of the imaging devices is selected when the vertical location of the given rack indicates that the given rack is beyond the specified distance of the imaging devices, wherein the operations comprise performing the action detection based on an analysis of the hand over multiple frames of the images.

20. The non-transitory computer-readable media of claim 18, wherein performing the action detection comprises classifying the hand as one of an inactive hand, an active hand, or a retracting hand and wherein:
classifying the hand as the inactive hand comprises classifying the hand as the inactive hand based on a determination that the hand is not holding the racked item;
classifying the hand as an active hand comprises classifying the hand as an active hand based on a determination that the hand is holding the racked item inside a boundary of the given rack; and
classifying the hand as a retracting hand comprises classifying the hand as a retracting hand based on a determination that the hand is holding the racked item and has transitioned from a first location that is inside a boundary of the given rack to a second location that is outside a boundary of the given rack.
